(19) United States
(12) Patent Application Publication
(10) Pub. No.: US 2019/0117353 A1
(43) Pub. Date: Apr. 25, 2019

(54) Groovy Dental Floss

(71) Applicant: John D. Bailey, Rockledge, FL (US)

(72) Inventor: John D. Bailey, Rockledge, FL (US)

(21) Appl. No.: 15/717,630

(22) Filed: Oct. 24, 2017

(51) Int. Cl. A61C 15/04

(52) U.S. Cl. CPC A61C 15/042; A61C 15/043; A61C 15/046

(57) ABSTRACT

A dental floss produced with dips, rises and knobs used for dental hygiene. The dental floss may be made of two polymers (synthetic compounds), either Nylon or Teflon. The dental floss is designed for removing debris and plaque from between the teeth and between the teeth and gums.

(I would not what to be restricted from using other materials should they be developed in the future. (Flosses have been made up silks, etc. in the past).

### FIELD OF THE INVENTION

The present invention relates to dental floss and more particularly to a groovy dental floss.

### BACKGROUND

The problem with existing flosses is not doing a more thorough job of removing debris/particles trapped between the teeth and teeth and gums.

### SUMMARY

The present invention removes debris that may be trapped between the teeth and teeth and gums after eating. The Groovy Floss design uses dips and rises with knobs on each side of the floss line. This creates a grouser effect like that of a tractor or tank treads to provide traction between the teeth and teeth and gums than existing floss. (or use unlike)

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a side view of a string of groovy floss of the present invention;

FIG. 2 illustrates a perspective view of the string of the groovy floss of the present invention.

### DETAILED DESCRIPTION

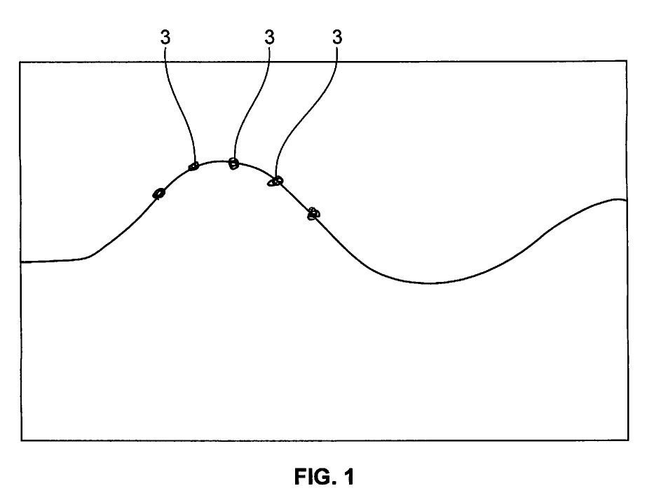

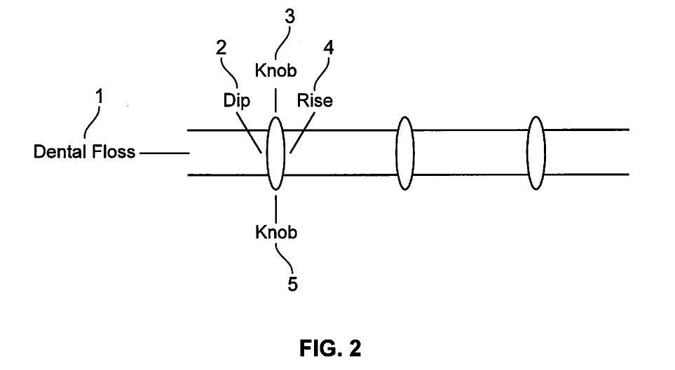

The present invention as illustrated in FIG. 1 and FIG. 2 includes a dental floss 1 that can be produced using different types of fibers/materials. This invention is different than existing materials used in existing dental floss. (similar to)

A floss line 1 of the present invention has dips 2 and rises 3 with knobs 4, 5 protruding on each side placed across floss 1.

The material used for the dips 2 and rises 3 can be the same as or different than that used for the floss.

The spacing of the dips 2 and rises 3 along the floss line 1 can be variable in the distance between them.

The dips 2, rises 3 and knobs 4, 5 located along the floss line 1 of the present invention produces a grouser effect as it's pulled through and between the teeth, teeth and gums. This effect of the present invention produces results like that of a tractor or tank treads, that will push/pull and loosen trapped debris and removes the debris as it's pulled or pushed through. A dental floss 1 removes debris/particles trapped between the teeth, the teeth and gums and to prevent the buildup of plaque.

The dental floss 1 will better remove debris from between the teeth, teeth and gums and also will slow down or prevent the buildup of plaque and prevent gum disease.

It is envisioned that this invention may require the integration of new and/or existing technologies to produce the product.

The material content of the floss 1 can be produced by using materials currently used by most vendors. Materials such as Teflon, Nylon (Polyesters), etc., combined with other ingredients are used to produce the floss 1 of the present invention. Also, to produce the present invention, another station may be used in manufacturing process to apply the material for forming the dips 2 and rises 3 along the floss line 1.

The floss 1 design with dips 2 and rises 3 resembles a tractor or tank treads catching and removing debris from between the teeth and teeth and gums as the floss thread is pulled between them.

FIG. 2 is an illustration of dental floss 1. The dips 2 and the knobs 4, 5 are used to keep down the buildup of plaque and remove particles of debris on the surface of the teeth. The knobs 4 and 5 on each side of the floss 1 removes debris trapped between the teeth and gums.

The floss 1 of the present invention can be applied/used by the user from floss 1 on spools provided in containers/dispensers, and a pick and floss 1 may be packaged separately. The floss 1 are (will be) used by wrapping the ends of the floss 1 around one's fingers, inserting the ribbon portion of the floss 1 between the teeth, then pulling the floss 1 forward, backwards, up and down by using their fingers.

A dental floss 1 produced with dips 2, rises 3 and knobs 4 used for dental hygiene. The dental floss may be made of two polymers (synthetic compounds), either Nylon or Teflon. The claimed dental floss 1 is designed for removing debris and plaque from between the teeth and between the teeth and gums. The present invention differs from existing floss' due to the dips 2 and rises 3 placed on the floss with overlapping knobs 4, 5 on each side. The dips 2 and rises 3, with overlapping knobs 4, 5, creates a grouser effect, to catch and remove debris trapped between the teeth and the teeth and gums. The functions of the present invention are like that of a tractor which loosens, pushes or pulls debris. The present invention can be manufactured with one (1) or more dips 2, rises 3 and knobs placed on the floss 1. Also, the number and size of the dips 2, rises 3 and knobs 4, 5 can vary. The thickness and width of the floss 1 can vary. The intent of the invention is to accommodate the flossing needs of people and animals.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A dental floss to clean teeth comprises: dips, rises and overlapping knobs formed on each side of the dental floss.
